(19) United States
(12) Patent Application Publication
(10) Pub. No.: US 2015/0338846 A1
(43) Pub. Date: Nov. 26, 2015

(54) A METHOD AND SYSTEM FOR QUALITY INSPECTION WITHIN A MULTI LAYER MANUFACTURING LIFECYCLE

(71) Applicant: GESTION PHITOPHE INC., Quebec (CA)

(72) Inventor: Stéphane BOIVIN, Lorraine (CA)

(21) Appl. No.: 14/400,377

(22) PCT Filed: Jul. 12, 2012
(86) PCT No.: PCT/CA2012/000676

§ 371 Date: Jan. 21, 2015

(51) Int. Cl. G05B 19/418; H04B 5/00; H04W 4/00

(52) U.S. Cl. CPC G05B 19/41875; H04W 4/008; H04B 5/0031; H04W 84/12

(57) ABSTRACT

The present relates to a method and system for performing quality inspection of a product, within a multi layer manufacturing lifecycle. For doing so, the present method and system receive, at a quality control platform, a quality control request for the product. The method and system process, at the quality control platform, the quality control request to generate a quality specification, and transmit the quality specification, from the quality control platform, to at least one portable quality inspection terminal. The method and system collect, at the at least one portable quality inspection terminal, quality data representative of a compliance of an article under inspection with the quality specification. The method and system process, at the at least one portable quality inspection terminal, the quality data to generate aggregated quality data; and transmit the aggregated quality data, from the at least one portable quality inspection terminal, to the quality control platform. The article under inspection is handled at a specific layer of the manufacturing lifecycle of the product.

### TECHNICAL FIELD

The present disclosure relates to the field of quality inspection in manufacturing activities; and more particularly to quality inspection in the context of a multi layer manufacturing lifecycle.

### BACKGROUND

In the context of a globalized economy, manufacturing of a product often requires several sub-contractors, for the effective manufacturing of the product. The designer/distributor/co-manufacturer focuses on conception, marketing, and sells activities. The manufacturing activities are subcontracted to one (or a combination of) manufacturing partner(s), who can accomplish them at a competitive cost.

In this context, it is not safe to wait until the delivery of the final product to the designer/distributor/manufacturer, to determine if this final product is compliant with pre-defined quality standards. In case of non compliance, there are usually only two costly (in terms of loss of time and money) options: reject the product and have a new one delivered, or have the product repaired. A more proactive approach consists in monitoring quality criteria at different stages of the manufacturing lifecycle, to anticipate a potential non compliance of the final product.

However, monitoring quality criteria at different stages of the manufacturing lifecycle of a product is a complex task. The manufacturing lifecycle usually comprises multiple stages, with different quality criteria at each stage. The monitoring of quality criteria is a resources intensive task, in terms of human and material resources. Thus, it shall be performed via efficient and reliable procedures. Furthermore, the premises of the designer/distributor/manufacturer of the product, and the manufacturing premises, are usually not collocated. This makes it difficult to implement quality procedures controlled by the designer/distributor/manufacturer of the product, on remote manufacturing premises. There is therefore a need for a method and system for performing quality inspection of a type of product within a multi layer manufacturing lifecycle.

### SUMMARY

The present disclosure relates to the field of quality inspection in manufacturing activities; and more particularly to quality inspection in the context of a multi layer manufacturing lifecycle.

According to a first aspect, the present disclosure provides a method for performing quality inspection of a type of product within a multi layer manufacturing lifecycle. The method comprises receiving at a quality control platform a quality control request for the type of product. The method further processes at the quality control platform the quality control request to generate a quality specification. The method transmits the quality specification from the quality control platform to at least one portable quality inspection terminal. The method also collects at the at least one portable quality inspection terminal quality data representative of a compliance of an article under inspection with the quality specification. The method then processes at the at least one portable quality inspection terminal the quality data to generate aggregated quality data, and transmits the aggregated quality data from the at least one portable quality inspection terminal to the quality control platform. The method further considers that the article under inspection is handled at a specific layer of the manufacturing lifecycle of the type of product.

In accordance with another aspect, the present disclosure further relates to a system for performing quality inspection of a type of product within a multi layer manufacturing lifecycle. The system comprises a quality control platform and at least one portable quality inspection terminal. The quality control platform receives a quality control request for the type of product, processes the quality control request to generate a quality specification, and transmits the quality specification from the quality control platform to at least one portable quality inspection terminal. The portable quality inspection terminal collects quality data representative of a compliance of an article under inspection with the quality specification, processes the quality data to generate aggregated quality data, and transmits the aggregated quality data from the portable quality inspection terminal to the quality control platform. The article under inspection being handled at a specific layer of the manufacturing lifecycle of the type of product.

The foregoing and other features of the present method and system will become more apparent upon reading of the following non-restrictive description of examples of implementation thereof, given by way of illustration only with reference to the accompanying drawings.

### BRIEF DESCRIPTION OF THE DRAWINGS

In the appended drawings:

FIGS. 1A and 1B illustrate a multi layer manufacturing lifecycle, according to a non-restrictive illustrative embodiment;

FIG. 2 illustrates a system for performing quality inspection of a type of product within a multi layer manufacturing lifecycle, according to a non-restrictive illustrative embodiment;

FIG. 3 illustrates a method for performing quality inspection of a type of product within a multi layer manufacturing lifecycle, according to a non-restrictive illustrative embodiment;

FIG. 4 illustrates a data model for quality inspection of a type of product within a multi layer manufacturing lifecycle, according to a non-restrictive illustrative embodiment;

FIG. 5 illustrates a quality control platform, according to a non-restrictive illustrative embodiment; and

FIG. 6 illustrates a portable quality inspection terminal, according to a non-restrictive illustrative embodiment.

### DETAILED DESCRIPTION

The present disclosure relates to the field of quality inspection, and more particularly to quality inspection in the context of a multi layer manufacturing lifecycle. A multi layer manufacturing lifecycle may be broken up in multiple performed for manufacturing a product. The term layer is used to represent the different stages, by reference to the different layers of the Open Systems Interconnection (OSI) model. Indeed, the different stages can be represented as a normalized succession of layers. Each layer of the manufacturing lifecycle consists in executing specific manufacturing operations. Each layer of the manufacturing lifecycle may be performed at one or several specific locations (e.g. a specific factory, or a specific division of a factory). Each layer of the manufacturing lifecycle involves specific manufacturing equipments, specific human resources. For each layer, one or several types of articles are received from the previous layer, transformed or incorporated into one or several new types of articles, which are provided to the next layer. And for each layer, a quality inspection of the one or several types of articles generated by the layer may be performed. Detecting a non compliance issue based on the quality inspection performed at a specific layer of the manufacturing lifecycle is more efficient than detecting a default on the final product. In most cases, a default on the final product is a consequence of a non compliance issue at a specific layer. By promptly identifying non-compliance early in the manufacturing lifecycle, important savings may be achieved, and overall improved quality and respect of delivery times met.

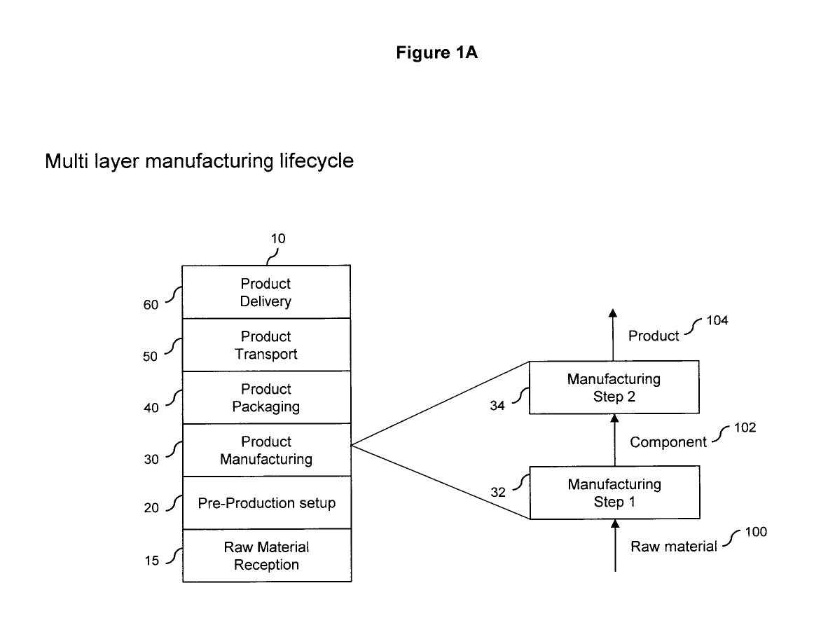

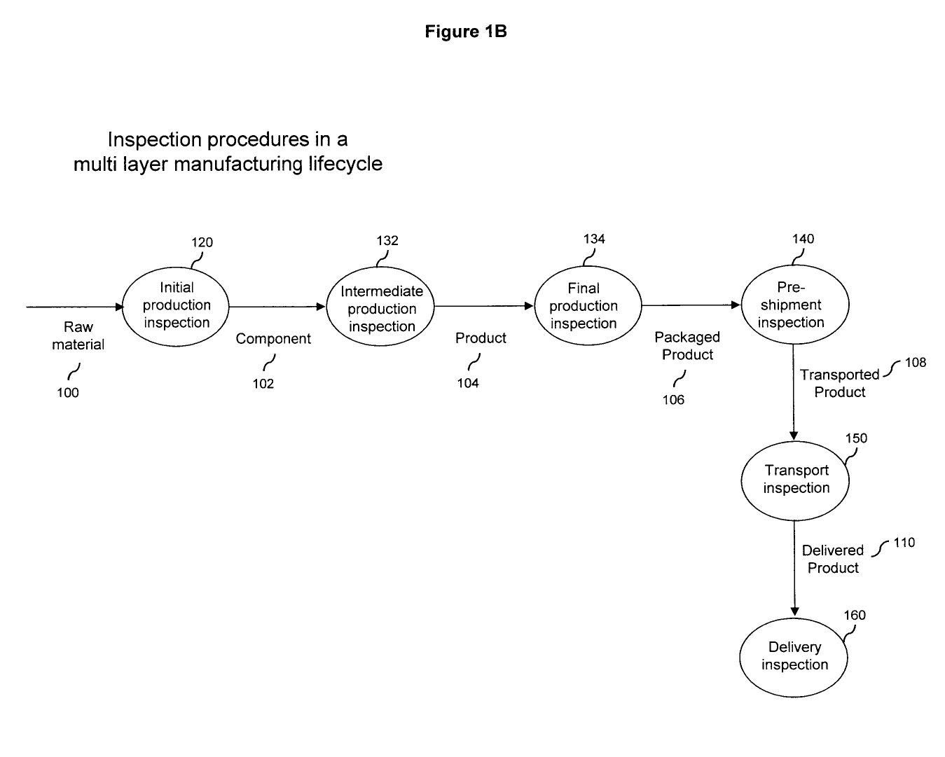

Referring now to FIGS. 1A and 1B, a multi layer manufacturing lifecycle will be described.

A multi layer manufacturing lifecycle 10 is represented in FIG. 1A. The manufacturing lifecycle 10 comprises the following layers: a raw material reception layer 15, a pre-production setup 20 a product manufacturing layer 30, a product packaging layer 40, a product transport layer 50, and a product delivery layer 60. The multi layer manufacturing lifecycle 10 may further comprise additional steps, such as product assembly, product installation, etc. which have not be represented in FIG. 1 for generalization purposes. Some layers of the manufacturing lifecycle may involve multiple complex processes, and may be further divided into sub-layers. For example, the product manufacturing layer 30 may be decomposed in a first manufacturing step 32, and a second manufacturing step 34. The multi layer manufacturing lifecycle 10 represented in FIG. 1A is for illustration purposes only. In another implementation of a multi layer manufacturing lifecycle 10, some layers represented in FIG. 1A may not be present, or be sub-divided to better represent the various steps from raw material to delivery of the product.

As represented in FIG. 1A, the manufacturing lifecycle 10 goes beyond pure manufacturing operations (illustrated by the product manufacturing layer 30). It takes into account several steps related to the production of a product, the transport of the product, up to the delivery of the product 60. The entity which receives the delivered product will be referred to as a client. The client may be an entity which sells and/or distributes the product.

Following is a description of the layers of the manufacturing lifecycle 10 represented in FIG. 1A. The raw material reception layer 20 consists in receiving raw materials, which are used to manufacture the product. One or several types of raw materials may be used, provided by one or several suppliers. Examples of such raw materials include wood, plastic, metals, etc. Some raw materials may be semi-manufactured, and still be considered as raw materials (e.g. semi-manufactured wood boards to build furniture).

The product manufacturing layer 30 consists in producing the product, using the raw materials and components. As illustrated in the sub-layers 32 and 34, one or several raw materials 100 may be used to manufacture a component 102. Then, one or several components 102 may be combined to manufacture the product 104. Some of the components used to manufacture the product 104 may be provided by external suppliers (not represented in FIG. 1A). For example, in the context of furniture, components may consist of doors, shelves, panels, etc.

The product packaging layer consists in preparing the product for delivery to the client, for instance conditioning the product in a delivery package. A different package may be used for each instance of a product, several instances of a product may be grouped in a single package, the product may be packaged as a set of components, etc. The raw material reception, product manufacturing, and product packaging, may take place at one location (at a manufacturing facility), or over several locations.

The product transport layer 50 consists in transporting the packaged product to the client facility. The transport may include one, or a combination of, terrestrial, maritime, and aerial, transport. As already mentioned, the product delivery layer 60 consists in the delivery of the product at the seller/distributor facility. Alternatively, the product transport layer 50 could consist in transporting the packaged product directly to a buyer of the product, so as to reduce transportation steps.

FIG. 1B illustrates exemplary inspection procedures in the context of the multi layer manufacturing lifecycle represented in FIG. 1A. Although specific steps are represented on FIG. 1B, the present method and system are not limited to such steps, which are represented for exemplary purposes only. In another implementation, some inspection procedures represented in FIG. 1B may not be present, and additional inspection procedures not represented in FIG. 1B may be present.

An initial inspection 120 may be performed on raw materials 100 used to manufacture the product. At the product manufacturing sub-layer 32 of FIG. 1A, one or several intermediate production inspection(s) 132 may be performed on components 102, subsets or sub-assemblies of the product. At the product manufacturing sub-layer 34 of FIG. 1A, a final production inspection 134 may be performed on the product 104. At the product packaging layer 40 of FIG. 1A, a pre-shipment inspection 140 may be performed on the packaged product 106. At the product transport layer 50 of FIG. 1A, a transport inspection 150 may be performed on the transported product 108. At the product delivery layer 60, a delivery inspection 160 is performed on the delivered product 110.

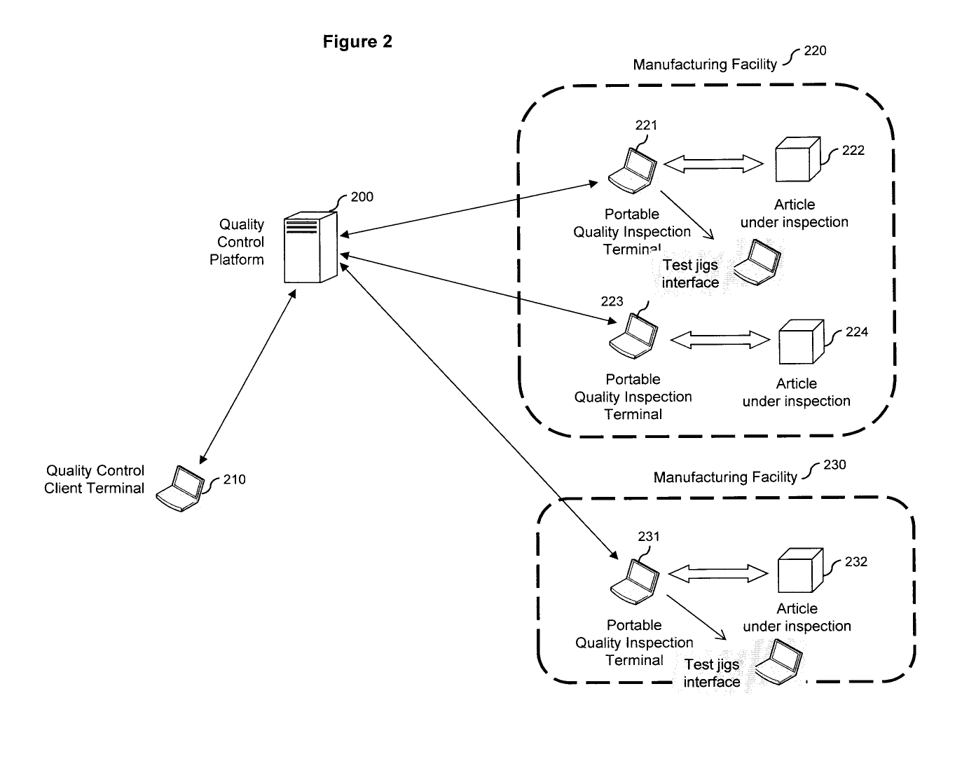

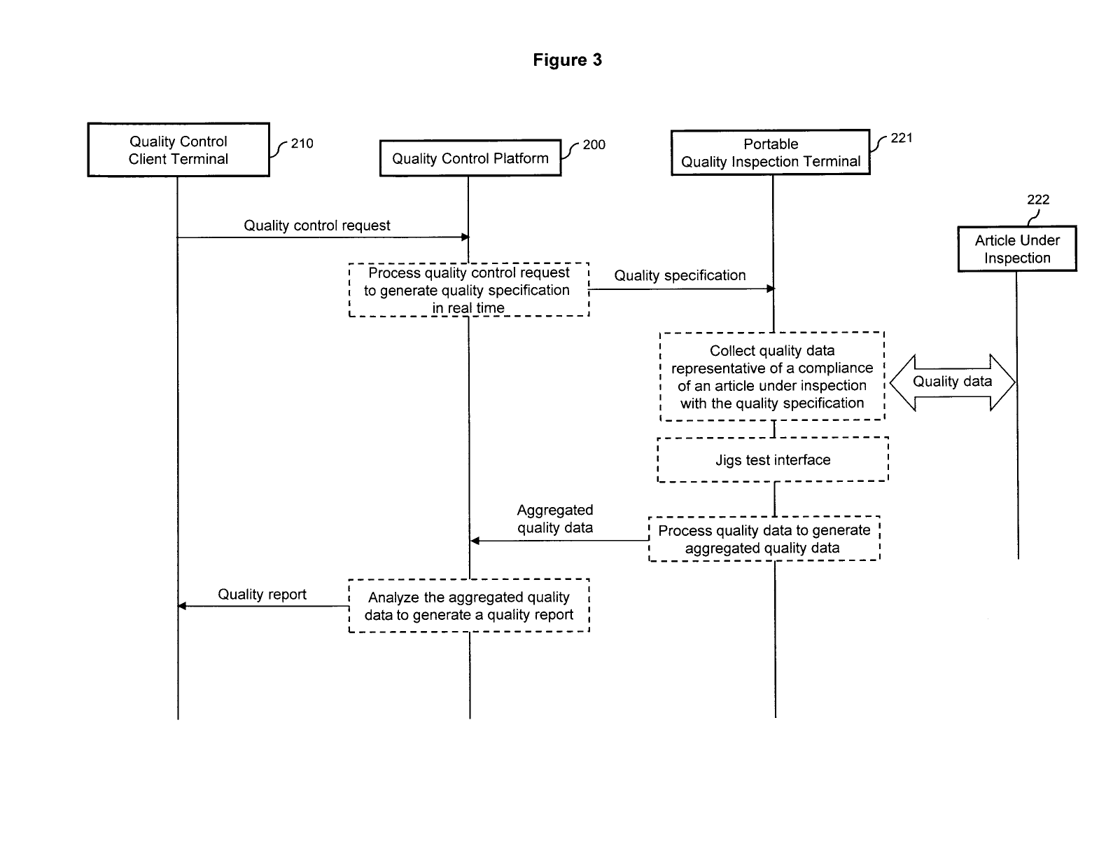

Referring now to FIGS. 2 and 3 concurrently, a method and system for performing quality inspection of a type of product within a multi layer manufacturing lifecycle will be described.

A quality control platform 200 is represented in FIG. 2. The quality control platform 200 is installed on a server or a computer. The quality control platform 200 interacts with at least one processor of the server or computer, and memory of the server, the computer or any other external memory to perform the various exchanges and analysis. The quality control platform 200 is operated by an independent third party, and manages inspection procedures (as represented in FIG. 1B) on behalf of a client. The client outsources the manufacturing of a type of product to one or several suppliers, according to a multi layer manufacturing lifecycle (as represented in FIG. 1A). The client interacts with the quality control platform 200, by means of a quality control client terminal 210. The quality control client terminal 210, and the quality control platform 200, exchange data in real time by means of a communication network, and appropriate secure communication protocols. The quality control client terminal 210 may consist of a computer, a tablet such as for example an android tablet, an intelligent phone, or any other electronic communication devices. The quality control client terminal 210 further comprises wired or wireless connection to connect and interface with test jigs tools. The quality control client terminal 210 may have installed thereon a software allowing communication with the quality control platform 200, or communicate with the quality control platform 200 through a portal, such as for example a web service, over the Internet.

The quality control platform 200 interacts over Internet or through wired or wireless communication with portable quality inspection terminals 221, 223, and 231. For illustration purposes, a first type of product is manufactured on behalf of the client, by a first supplier at a fist manufacturing facility 220. And a second type of product is manufactured on behalf of the client, by a second supplier at a second manufacturing facility 230. The portable quality inspection terminal 221 implements an inspection procedure (as represented in FIG. 1B), corresponding to a layer of the manufacturing lifecycle (as represented in FIG. 1A) of the first type of product. The portable quality inspection terminal 223 implements another inspection procedure (as represented in FIG. 1B), corresponding to another layer of the manufacturing lifecycle (as represented in FIG. 1A) of the first type of product. Then, the portable quality inspection terminal 231 implements an inspection procedure (as represented in FIG. 1B), corresponding to a layer of the manufacturing lifecycle (as represented in FIG. 1A) for the second type of product. The portable quality inspection terminals (221, 223, and 231), and the quality control platform 200, exchange data by means of a communication network, and appropriate communication protocols.

The portable quality inspection terminals (221, 223, and 231) implement inspection procedures on articles under inspection (respectively 222, 224, and 232). An article under inspection is an instance of a type of article handled at a specific layer of the manufacturing lifecycle of a type of product. Examples of articles under inspection include raw materials, components, sub-components, sub-assemblies, products, packaged products, transported products, and delivered products (as illustrated in FIG. 1B). The portable quality inspection terminals (221, 223, and 231) are generally operated by employees of a third party inspection firm, who perform the inspection procedures, under the control of the third party which operates the quality control platform 200.

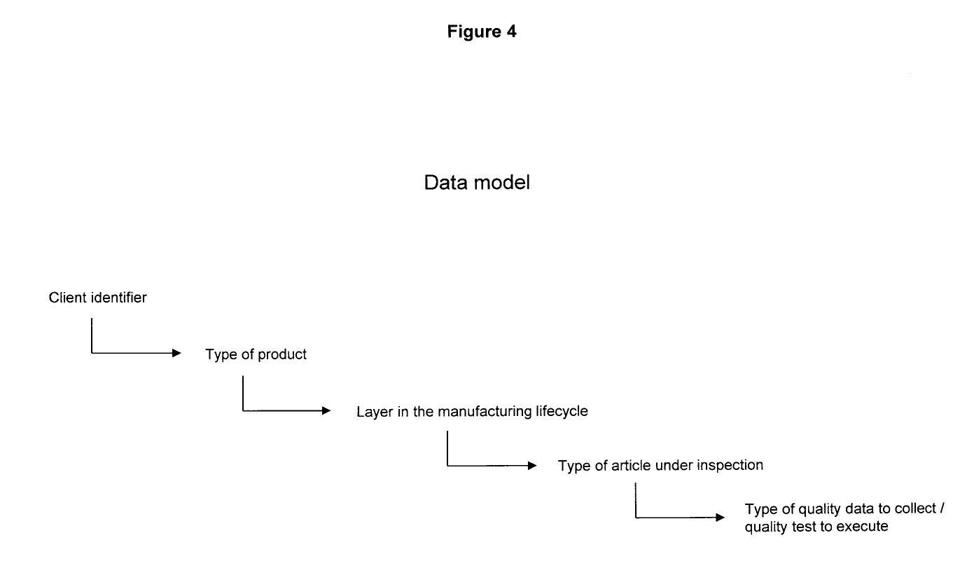

The quality control platform 200 stores a data model for each type of product, and on a per client basis. For example, for a same product, different clients may require different quality inspections. The data model comprises the different layers of the manufacturing lifecycle of the type of product (as represented in FIG. 1A). For each layer, the data model comprises the types of articles produced/handled at this layer, the identification of the corresponding manufacturer, the identification/localization of the corresponding manufacturing facility. The types of articles produced/handled at a layer correspond to the articles under inspection (222, 224, and 232). For each type of article produced/handled, the data model comprises the corresponding inspection procedure. An inspection procedure consists in a list of quality tests, and a number of products to be inspected. Each quality test determines the compliance of a feature of the article under inspection with a specification of the feature. For each quality test, a corresponding type of quality data to collect is also specified. The description of the aforementioned data model is for illustration purposes only. In another implementation of the data model, some information described previously may not be present, and additional information may be present. FIG. 4 illustrates an exemplary data model.

We now consider that a data model for a first type of product manufactured for a client has been defined by the client, and stored at the quality control platform 200. The client may thus select the extent of the quality inspection performed, define the quality inspections tests to be performed at each layer of the lifecycle, the number or quantity of raw material, components, sub-components, sub-assemblies and product to be inspected for each layer of the lifecycle. The various quality inspections may be performed on an automatic basis, on a per request basis, or a combination thereof. Thus the present quality control platform provides a customized quality inspection solution for each product of each client.

For illustration purposes, the instances of the type of article for the client correspond to the article under inspection 222, produced/handled at the manufacturing facility 220. The following example represents a quality inspection triggered by the client. A quality control request for the type of product is generated at the quality control client terminal 210 and received at the quality control platform 200. The quality control platform 200 processes the quality control request, to generate a quality specification. The quality specification is generated, based on parameters of the quality control request, and information stored in the quality control platform 200 (e.g. the data model for the type of product and type of inspection to be performed).

The quality specification is transmitted from the quality control platform 200, to at least one portable quality inspection terminal 221. The portable quality inspection terminal 221 collects quality data, representative of a compliance of an article under inspection 222 with the quality specification. As mentioned previously, the article under inspection 222 comprises one of: a raw material used to manufacture an instance of the type of product, a component used to manufacture an instance of the type of product, or an instance of the type of product. An instance of the type of product is taken in a broad sense, to include the product, the packaged product, the transported product, and the delivered product (as illustrated in FIG. 1B).

The portable quality inspection terminal 221 processes the quality data, to generate aggregated quality data. The aggregated quality data may correspond (after processing and aggregation) to the quality data collected for a subset of the quality tests of the quality specification. Alternatively, the aggregated quality data may correspond (after processing and aggregation) to the quality data collected for an instance of the type of article under inspection 222. And, the aggregated quality data may correspond (after processing and aggregation) to the quality data collected for several instances of the type of article under inspection 222. The aggregated quality data are transmitted from the portable quality inspection terminal 221, to the quality control platform 200.

The aggregated quality data are further analyzed at the quality control platform 200, to generate a quality report for the type of product. The quality report is transmitted from the quality control platform 200, to the quality control client terminal 210 (which sent the quality control request for the type of product). Base on the quality standards set at beginning of the process, the inspection will therefore be accepted or be rejected. For instance, the quality report may contain statistics representing the quality of a type of article, based on aggregated quality data for instances of the type of article. The quality report may also combine statistics representing the quality of several types of articles, based on aggregated quality data for instances of the types of articles. And the quality report may combine statistics based on currently received aggregated quality data, with memorized statistics based on previously received aggregated quality data, to represent the evolution of the quality of a type or several types of articles (included in a type of product). Alternately, the quality report may comprise specific quality data information for each instance that does not meet the expected quality requirement. The specific quality data information may comprise for example specific test measurements, pictures, difference from the expected quality requirement, a written or verbal comment from the inspect having effectuated the inspection, etc.

As mentioned previously, the quality control request comprises parameters, processed by the quality control platform 200, to generate the quality specification. The quality control request comprises a combination of at least one of the following parameters.

An identification of the client terminal 210 which sent the quality control request. Since the quality control platform 200 may be used by several clients and several users for each client, the identification of the client terminal 210 may be used as a unique identifier, to uniquely identify a specific user of a client. For instance, the unique identifier is used to access the specific data model(s) stored in the quality control platform 200, corresponding to the specific client. When the quality control platform 200 is used by several clients, the confidentiality of the data of a specific client must be guaranteed. The use of a unique identifier, along with security mechanisms well known in the art, guarantees the confidentiality of such data.

A type of product. Since the quality control platform 200 may be used to control the quality of several types of products for the same client, an identifier of the specific type of product targeted by the quality control request is used. In the instance when one type of product is manufactured by more than one manufacturer, a manufacturer may also be selected.

A layer and step in the manufacturing life cycle of the type of product. Using the data model of the type of product, all the types of articles under inspection (corresponding to the specified layer and step in the manufacturing life cycle of the type of product) may be selected. Alternatively, the quality control request may directly identify one or several types of article under inspection.

A specific type of quality data to collect. For a specific type of article under inspection, several types of quality data may be collected (as will be detailed later in the description). The quality control request may include one or several types of quality data to collect, for a given type of article under inspection. Alternatively, the quality control request may indicate a specific quality test to execute at a portable quality inspection terminal, for collecting a specific type of quality data. The types of quality data to collect and the corresponding quality tests to execute for a type of article under inspection, are described in the data model of the type of product (stored in the quality control platform 200).

A definition of a sample of a type of article under inspection, for which quality data are collected. The definition of the sample determines which instances of a type of article under inspection are inspected. For example, only a percentage of the instances may be inspected. The inspected instances may be selected randomly (e.g. one out of ten). Alternatively, the instances may be selected based on specific criteria (e.g. specific color, specific feature present or absent, suspicion of the presence of a default by visual inspection, etc).

A time and date at which quality data are collected. The client may determine a tentative time and date, based on its own constraints, and constraints from the involved manufacturers (which produce/handle the articles to be inspected). This tentative time and data may be modified by the quality control platform 200, based on its own constraints (as will be detailed later in the specification).

As mentioned previously, the quality control request is processed at the quality control platform 200, to generate a quality specification. The quality specification comprises parameters indicating which types of article shall be inspected, and which types of quality data shall be collected/which types of quality tests shall be performed to collect the quality data. The parameters of the quality specification are determined, by analysing the parameters of the quality control request, in view of the data model for the type of product (stored in the quality control platform 200). Some default values may be stored in the data model, in the case where some parameters are not present in the quality control request. For example, for a specific type of article under inspection, pre-defined types of quality data to collect/quality tests to execute, may be stored in the data model. In this case, the default values are used for the corresponding parameters of the quality specification. The quality specification comprises a combination of at least one of the following parameters.

A type of article under inspection. This parameter is either the one specified in the quality control request, or determined, based on the layer in the manufacturing life cycle of the type of product (specified in the quality control request), and corresponding pre-defined values (in the data model) for the type of article under inspection.

A specific type of quality data to collect. This parameter is either the one specified in the quality control request, or determined, based on the selected type of article under inspection, and corresponding pre-defined values (in the data model) for this type of article under inspection.

A specific quality test to execute at a portable quality inspection terminal, for collecting a specific type of quality data. This parameter is either the one specified in the quality control request, or determined, based on the selected type of article under inspection, and corresponding pre-defined values (in the data model) for this type of article under inspection.

A definition of a sample of a type of article under inspection for which quality data are collected. This parameter is either the one specified in the quality control request, or determined, based on the selected type of article under inspection, and corresponding pre-defined values (in the data model) for this type of article under inspection.

A time and date at which quality data are collected. This parameter is either the one specified in the quality control request, or it is determined, based on additional constraints managed by the quality control platform 200. Such constraints include: the availability of portable quality inspection terminals 221 at the requested time and date; and the availability of testers to operate these terminals.

An identification of a portable quality inspection terminal and/or an identification of a tester to operate a portable quality inspection terminal. As mentioned above, the quality control platform 200 manages the material (portable terminals) and human (testers) resources, required to execute the inspection defined by the quality specification. The inspection is performed by a third party inspection firm (or several third party firms), whose material and human resources are managed by the third party operating the quality control platform 200. This management is transparent to the client. The generation of the quality specification includes the booking of the required material and human resources, at the time and date at which the inspection shall be performed.

As mentioned previously, the portable quality inspection terminal 221 collects quality data, representative of a compliance of the article under inspection 222, with the quality specification. The collection of the quality data is performed according to the operational parameters of the quality specification: at the specified time and date for the collection, with the terminal corresponding to the specified identification of a portable quality inspection terminal 221, by the tester corresponding to the specified identification of a tester. Further, if a sample of the type of article under inspection has been specified, the collection of the quality data is performed only for the articles under inspection 222 corresponding to the specified sample. Otherwise, quality data are collected for all articles under inspection 222.

The collection of quality data is performed for each type of quality data to collect/quality test to execute, as specified in the quality specification. Following are examples of quality data representative of a compliance of the article under inspection 222 with the quality specification.

A model. A type of article may have several variants in terms of models. The quality test consists in verifying that the articles under inspection are compliant with the model(s) defined in the quality specification.

A material. A type of article may include several variants of a material (e.g. several types of woods for furniture). The quality test consists in verifying that the articles under inspection are compliant with the material(s) defined in the quality specification.

A color. A type of article may have several variants of color. The quality test consists in verifying that the articles under inspection are compliant with the color(s) defined in the quality specification.

An appearance. A type of article may have several variants in terms of appearance. For example, the shape or the thickness of a sub-component of the type of article may vary. The quality test consists in verifying that the articles under inspection are compliant with the appearance(s) defined in the quality specification.

A functionality. A type of article may have several variants in terms of functionality. For example, a functionality may be present or not (e.g. an article of furniture may have two or three feet). The quality test consists in verifying that the articles under inspection are compliant with the functionality(ies) defined in the quality specification.

A labeling. A type of article may have a specific labeling. For example, a specific Stock Keeping Unit (SKU) may be used. The quality test consists in verifying that the articles under inspection are compliant with the labeling defined in the quality specification.

A packaging. A type of article may have a different packaging, depending on whether the articles will be shipped by truck, plane, or boat. The quality test consists in verifying that the articles under inspection are compliant with the packaging defined in the quality specification.

A measure. A type of article may have several variants in terms of measure. For example, the length/width/height of an article of furniture may have several possible values. The quality test consists in verifying that the articles under inspection are compliant with the measure(s) defined in the quality specification.

A weight. A type of article may have several variants in terms of weight. The quality test consists in verifying that the articles under inspection are compliant with the weight(s) defined in the quality specification.

A number of instances. A type of article may have a specific constraint on the number of instances of the type of article to be produced/handled over a given period of time. The quality test consists in verifying that the articles under inspection are compliant with the number of instances defined in the quality specification.

A container loading pattern. For the transport of instances of a type of article, specific container loading patterns may be set, to minimize the volume, and thus the cost. The quality test consists in verifying that the articles under inspection are compliant with the container loading pattern(s) defined in the quality specification.

The quality data corresponding to a quality test may be automatically collected by the portable quality inspection terminal 221, from the article under inspection 222. Alternatively, the tester who operates the portable quality inspection terminal 221 may perform the quality test (e.g. a visual/manual inspection) of the article under inspection 222, and enter corresponding quality data in the portable quality inspection terminal 221.

The quality data comprise inspection reports. An inspection report may correspond to all the data entered by the tester in the portable quality inspection terminal 221, for a specific quality test. For example, a spreadsheet corresponding to the specific quality test is displayed on the terminal 221, and the tester enters appropriate inspection data in pre-defined fields.

The quality data also comprise photos and videos. A camera may be embedded in the portable quality inspection terminal 221, to directly take photos or videos of an instance (or several instances) of the type of article under inspection 222. These photos and videos are representative of various types of compliance criteria (e.g. color, appearance, packaging, etc).

The quality data may be collected by means of a short range communication technology. Examples of short range communication technologies included: Wireless Local Area Network (WLAN), Bluetooth, Radio Frequency Identification (RFID), and Near Field Communication (NFC). For example, some data stored in a memory of articles under inspection equipped with a WLAN or Bluetooth communication interface, may be collected by a portable quality inspection terminal 221, equipped with a similar WLAN or Bluetooth communication interface. Quality data are then further inferred from the collected data. Additionally, a portable quality inspection terminal 221, equipped with RFID or NFC communication means, may directly read a labeling (e.g. a SKU) on the articles under inspection 222.

The quality data may be of two types. Either, a strict indication of the compliance of the article under inspection 222, with the quality specification: the article is compliant, or not. Alternatively, the effective value of the characteristic of the article under inspection 222 is recorded, along with the strict indication of the compliance. For example, if a type of article shall include 50% of instances with the color blue and 50% with the color red, the effective color of the instances may also be recorded. This allows the calculation of the effective percentages (e.g. 55% are blue, 45% are red), which can be compared to the target percentages (50%). A strict indication of the compliance only indicates that 5% of the articles are not compliant.

As mentioned previously, the portable quality inspection terminal 221 processes the quality data, to generate aggregated quality data. Various types of aggregation may be performed. For example, the quality data are aggregated per instance of the type of article under inspection (combining all quality tests). Or per instance of quality test (combining all instances of the type of article under inspection). Then, the aggregated quality data are transmitted, from the portable quality inspection terminal 221, to the quality control platform 200. And the aggregated quality data are further analyzed at the quality control platform 200, to generate a quality report for the type of product. The quality report is transmitted from the quality control platform 200, to the quality control client terminal 210.

In one embodiment, the portable quality inspection terminal 221 transmits raw aggregated quality data, and the analysis to generate the quality report for the type of product is performed entirely at the quality control platform 200. In another embodiment, the portable quality inspection terminal 221 performs part of the analysis on the aggregated quality data. And the quality control platform 200 completes the analysis of the aggregated quality data, to generate the quality report. For example, the portable quality inspection terminal 221 performs the analysis for the type of article under inspection 222 under its supervision. Then, the quality control platform 200 performs the aggregation (and further refinement) of the analysis of all types of articles which constitute the type of product (received from multiple portable quality inspection terminals (221 and 223)).

The quality control platform 200 may also perform cross product analysis for a given client. For example, if two types of products (designed by the same client) include the same type of article, the quality control platform 200 may combine quality reports for the two types of products, to better analyze the compliance of the this type of article with quality specifications. Additionally, the quality control platform 200 may perform cross client analysis (while respecting the confidentiality of the data of each client when appropriate). For example, if two different clients design a type of product including the same type of article, the quality control platform 200 may combine quality reports for the two clients, to better analyze the compliance of the this type of article with quality specifications. This may allow the detection of a supplier who generally performs poorly in terms of quality compliance. Or to detect specific conditions under which the supplier performs poorly in terms of quality compliance.

The portable quality inspection terminals (221, 223, and 231) are computing devices, with the particularity to be easily transportable within the premises of a manufacturing facility. Examples of such computing devices include tablets, laptops, and smart phones. These computing devices include data processing capabilities, data storage capabilities, data entry/visualization capabilities, communication capabilities (to communicate with the quality control platform 200). Examples of communication capabilities include cellular network connectivity, or fixed broadband connectivity. Additionally, these computing devices may include a camera, and short range communication capabilities, as mentioned earlier in the description.

The quality control platform 200 is a computing device with substantial data processing and data storage capabilities. Examples of such computing devices include servers. The computing device may include a database, and a dedicated analytic software. The computing device also includes communication capabilities (to communicate with the portable quality inspection terminals (221, 223, and 231), and the quality control client terminal 210.

The quality control client terminal 210 includes various types of computing devices; for instance computers, laptops, tablets, smart phones, etc. (with communication capabilities to communicate with the quality control platform 200).

The quality control platform 200 receives and processes multiple quality control requests, for several types of products, from several client terminals 210. The quality control platform 200 generates quality specifications corresponding to the received multiple quality control requests. And the quality control platform 200 transmits the generated quality specifications to portable quality inspection terminals (221, 223, and 231), located at different facilities (220 and 230), corresponding to specific layers of the manufacturing lifecycles of the several types of products.

In a first example, FIG. 2 illustrates a configuration with a single client (210) designing two different types of products. The first type of product includes two types of articles (222 and 224), produced/handled at the manufacturing facility 220. The second type of product includes one type of article, 232 produced/handled at the manufacturing facility 230. The quality control platform 220 manages quality inspections, on behalf of a single client 210, for the two types of products, and for the corresponding types of articles, by means of interactions with the appropriate portable quality inspection terminals 221, 223, and 231. A first quality report (for the first type of product) is generated by the quality control platform 220, based on the aggregated inspection reports from the portable quality inspection terminals 221 and 223. A second quality report (for the second type of product) is generated by the quality control platform 220, based on the aggregated inspection reports from the portable quality inspection terminal 231.

In a second example, FIG. 2 illustrates a configuration with two clients (only one, 210, is represented in FIG. 2), each client designing one type of product. The first type of product includes two types of articles (222 and 232), produced/handled at two manufacturing facilities 220 and 230. The second type of product includes one type of article 224, produced/handled at the manufacturing facility 220. This example illustrates the case of two different clients using the same supplier, at the same manufacturing facility 220. The quality control platform 220 manages quality inspections, on behalf of both clients (only one, 210, is represented in FIG. 2), for the two types of products, and for the corresponding types of articles, by means of interactions with the appropriate portable quality inspection terminals 221, 223, and 231. A first quality report (for the type of product of the first client) is generated by the quality control platform 220, based on the aggregated inspection reports from the portable quality inspection terminals 221 and 231. A second quality report (for the type of product of the second client) is generated by the quality control platform 220, based on the aggregated inspection reports from the portable quality inspection terminal 223.

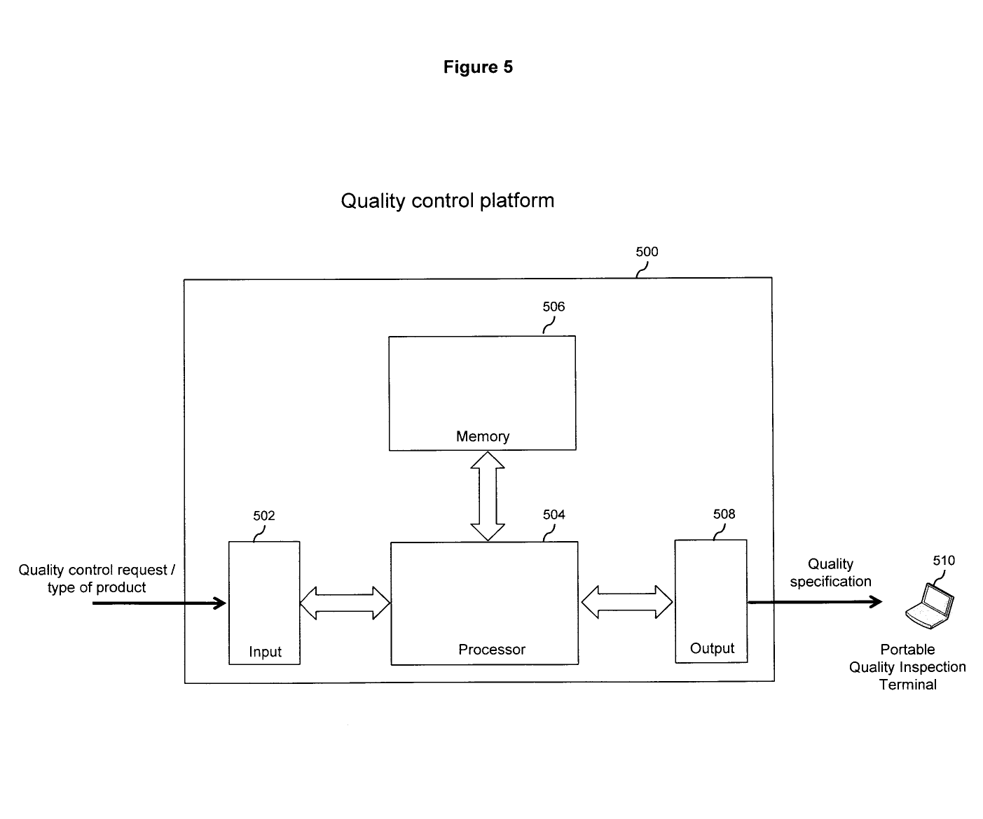

Referring now to FIG. 5, a quality inspection platform will be described. The quality control platform 500 comprises an input 502, for receiving a quality control request or a type of product. The quality control platform 500 also comprises a processor 504, for processing the quality control request, as previously described. The processing generates a quality specification for an article under inspection handled at a specific layer of a manufacturing lifecycle of the type of product. The quality control platform 500 further comprises a memory 506, for storing the quality specification for the type of product, and an output 508, for transmitting the quality specification from the quality control platform 500, to at least one portable quality inspection terminal 510.

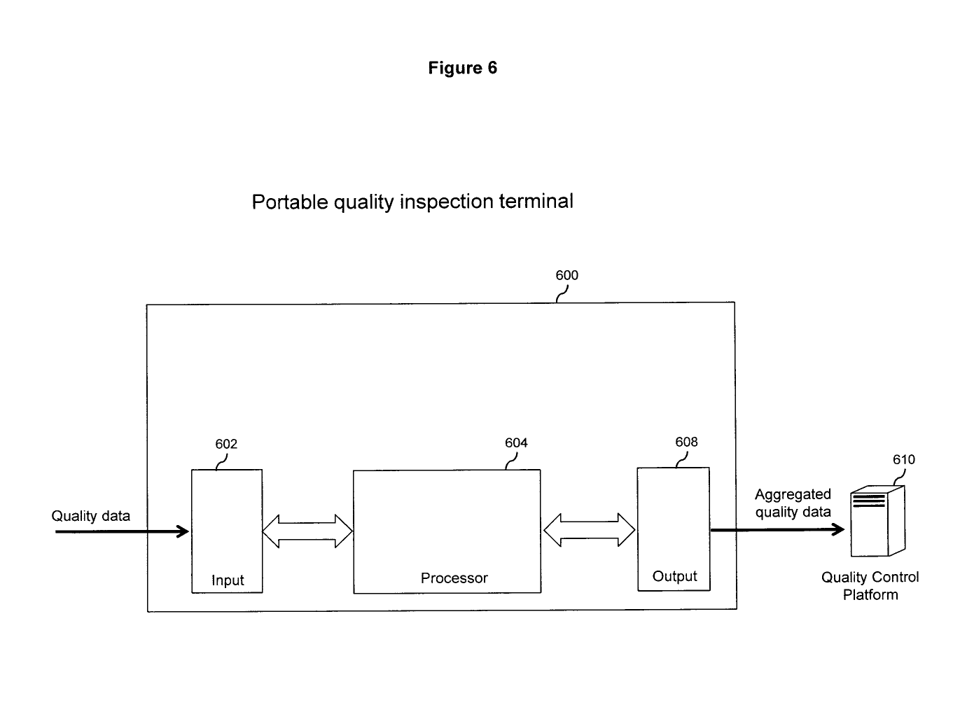

Referring now to FIG. 6, a portable quality inspection terminal will be described. The portable quality inspection terminal 600 comprises an input 602, for collecting quality data representative of a compliance of an article under inspection with a quality specification. The article under inspection is handled at a specific layer of a manufacturing lifecycle of a type of product. The portable quality inspection terminal 600 comprises a processor 604, for processing the quality data to generate aggregated quality data, and an output 608, for transmitting the aggregated quality data from the portable quality inspection terminal 600, to a quality control platform 610. The portable quality inspection terminal 600 may further comprises one or several inputs, for receiving the quality specification, for connecting to test jigs either wired or wirelessly so as to actuate tests and collect measurements therefrom, as previously discussed.

Although the present system, platform, inspection terminal and method have been described in the foregoing description by way of illustrative embodiments thereof, these embodiments can be modified at will, within the scope of the appended claims without departing from the spirit and nature of the appended claims.

1. A method for performing quality inspection of a type of product within a multi layer manufacturing lifecycle, the method comprising:
receiving at a quality control platform a quality control request for the type of product;
processing at the quality control platform the quality control request to generate a quality specification;
transmitting the quality specification from the quality control platform to at least one portable quality inspection terminal;
collecting at the at least one portable quality inspection terminal quality data representative of a compliance of an article under inspection with the quality specification;
processing at the at least one portable quality inspection terminal the quality data to generate aggregated quality data; and
transmitting the aggregated quality data from the at least one portable quality inspection terminal to the quality control platform;
wherein the article under inspection is handled at a specific layer of the manufacturing lifecycle of the type of product.

2. The method of claim 1, wherein the aggregated quality data are further analyzed at the quality control platform, to generate a quality report for the type of product; and the quality report is transmitted from the quality control platform to a client terminal which sent the quality control request for the type of product.

3. The method of claim 1, wherein:
the article under inspection comprises one of: a raw material used to manufacture an instance of the type of product, a component used to manufacture an instance of the type of product, or an instance of the type of product: and
the quality data representative of a compliance of an article under inspection with the quality specification comprise at least one of: a model, a material, a color, an appearance, a functionality, a labeling, a packaging, a measure, a weight, a number of instances, and a container loading pattern.

4. The method of claim 1, wherein the manufacturing lifecycle of the type of product comprises a combination of at least one of: a raw material reception layer, a product manufacturing layer, a product packaging layer, a product transport layer, and a product delivery layer.

5. The method of claim 1, wherein:
the quality control request comprises a combination of at least one of: an identification of a client terminal which sent the quality control request, a type of product, a layer in the manufacturing life cycle of the type of product, a type of article under inspection, a specific type of quality data to collect, a specific quality test to execute at a portable quality inspection terminal for collecting a specific type of quality data, a definition of a sample of a type of article under inspection for which quality data are collected, and a time and date at which quality data are collected;
the quality specification comprises a combination of at least one of: a type of article under inspection, a specific type of quality data to collect, a specific quality test to execute at a portable quality inspection terminal for collecting a specific type of quality data, a definition of a sample of a type of article under inspection for which quality data are collected, a time and date at which quality data are collected, an identification of a portable quality inspection terminal, and an identification of a tester to operate a portable quality inspection terminal; and
the quality data comprise inspection reports, photos, and videos.

6. (canceled)

7. (canceled)

8. (canceled)

9. The method of claim 1, wherein some quality data are collected by the portable quality inspection terminal from the article under inspection by means of a short range communication technology; the short range communication technology comprising one of: Wireless Local Area Network (WLAN), Bluetooth, Radio Frequency Identification (RFID), and Near Field Communication (NFC).

10. The method of claim 1, wherein the quality control platform receives and processes multiple quality control requests for several types of products from several client terminals, generates quality specifications corresponding to the received multiple quality control requests, and transmits the generated quality specifications to portable quality inspection terminals located at different facilities corresponding to specific layers of the manufacturing lifecycles of the several types of products.

11. A system for performing quality inspection of a type of product within a multi layer manufacturing lifecycle, the system comprising:
a quality control platform for:
receiving a quality control request for the type of product;
processing the quality control request to generate a quality specification; and
transmitting the quality specification from the quality control platform to at least one portable quality inspection terminal; and
a portable quality inspection terminal for:
collecting quality data representative of a compliance of an article under inspection with the quality specification;
processing the quality data to generate aggregated quality data; and
transmitting the aggregated quality data from the portable quality inspection terminal to the quality control platform;
wherein the article under inspection is handled at a specific layer of the manufacturing lifecycle of the type of product.

12. The system of claim 11, wherein the aggregated quality data are further analyzed at the quality control platform, to generate a quality report for the type of product; and the quality report is transmitted from the quality control platform to a client terminal which sent the quality control request for the type of product.

13. The system of claim 11, wherein the article under inspection comprises one of: a raw material used to manufacture an instance of the type of product, a component used to manufacture an instance of the type of product, or an instance of the type of product.

14. The system of claim 11, wherein the manufacturing lifecycle of the type of product comprises a combination of at least one of: a raw material reception layer, a product manufacturing layer, a product packaging layer, a product transport layer, and a product delivery layer.

15. The system of claim 1, wherein the quality control request comprises a combination of at least one of: an identification of a client terminal which sent the quality control request, a type of product, a layer in the manufacturing life cycle of the type of product, a type of article under inspection, a specific type of quality data to collect, a specific quality test to execute at a portable quality inspection terminal for collecting a specific type of quality data, a definition of a sample of a type of article under inspection for which quality data are collected, and a time and date at which quality data are collected.

16. The system of claim 1, wherein the quality specification comprises a combination of at least one of: a type of article under inspection, a specific type of quality data to collect, a specific quality test to execute at a portable quality inspection terminal for collecting a specific type of quality data, a definition of a sample of a type of article under inspection for which quality data are collected, a time and date at which quality data are collected, an identification of a portable quality inspection terminal, and an identification of a tester to operate a portable quality inspection terminal.

17. The system of claim 11, wherein the quality data representative of a compliance of an article under inspection with the quality specification comprise at least one of: a model, a material, a color, an appearance, a functionality, a labeling, a packaging, a measure, a weight, a number of instances, and a container loading pattern.

18. The system of claim 11, wherein the quality data comprise inspection reports, photos, and videos.

19. The system of claim 11, wherein some quality data are collected by the portable quality inspection terminal from the article under inspection by means of a short range communication technology; the short range communication technology comprising one of: Wireless Local Area Network (WLAN), Bluetooth, Radio Frequency Identification (RFID), and Near Field Communication (NFC).

20. The system of claim 11, wherein the quality control platform receives and processes multiple quality control requests for several types of products from several client terminals, generates quality specifications corresponding to the received multiple quality control requests, and transmits the generated quality specifications to portable inspection terminals located at different facilities corresponding to specific layers of the manufacturing lifecycles of the several types of products.

21. (canceled)

22. A portable quality inspection terminal comprising:
an input for collecting quality data representative of a compliance of an article under inspection at a specific layer of a manufacturing lifecycle with a quality specification;
a processor for processing the quality data to generate aggregated quality data; and
an output for transmitting the aggregated quality data from the portable quality inspection terminal to a quality control platform.
